(19) United States
(12) Patent Application Publication
(10) Pub. No.: US 2024/0378257 A1
(43) Pub. Date: Nov. 14, 2024

(54) DISPLAY CONTROL DEVICE, DISPLAY CONTROL METHOD, AND DISPLAY CONTROL PROGRAM

(71) Applicant: NIPPON TELEGRAPH AND TELEPHONE CORPORATION, Tokyo (JP)

(72) Inventors: Naoki FUKUSHI, Musashino-shi, Tokyo (JP); Takashi KOIDE, Musashino-shi, Tokyo (JP)

(73) Assignee: NIPPON TELEGRAPH AND TELEPHONE CORPORATION, Tokyo (JP)

(21) Appl. No.: 18/687,852

(22) PCT Filed: Sep. 2, 2021
(86) PCT No.: PCT/JP2021/032240

§ 371 Date: Feb. 29, 2024

(51) Int. Cl. G06F 16/957; G06Q 30/0241; H04L 9/40

(52) U.S. Cl. CPC G06F 16/9577; G06Q 30/0277; H04L 63/1483

(57) ABSTRACT

A display control device acquires an intermediate page including an advertisement, the intermediate page being displayed after a user clicks an advertisement type shortened URL. Next, the display control device analyzes HTML source code of the acquired intermediate page, and detects a correct button which is a button for transitioning to the web page of the URL of the shortening source or the next intermediate page from the HTML source code. Thereafter, the display control device performs display control to highlight a correct button on the intermediate page. Further, in a case where the intermediate page includes a CAPTCHA, the display control device performs display control to highlight the CAPTCHA.

### TECHNICAL FIELD

The present invention relates to a display control device, a display control method, and a display control program.

### BACKGROUND ART

Conventionally, an advertisement having a security risk (for example, a phishing site, drive-by download, or the like) may be displayed on a web page of an advertisement type shortened URL service.

For example, when a user accesses an advertisement type shortened URL, a web page (intermediate page) including an advertisement is displayed, and it is necessary for the user to click a correct button on the intermediate page in order to reach the URL of the shortening source.

Here, an advertisement (lure button) similar to a correct button may be displayed on the intermediate page. If the user clicks the advertisement on the intermediate page, the user may be guided to a site with a security risk.

### CITATION LIST

### Non Patent Literature

Non Patent Literature 1: Stranger Danger: Exploring the Ecosystem of Ad-based URL Shortening Services, [retrieved on Aug. 11, 2021], the Internet <https://www.researchgate.net/publication/261960583_Strange r_danger_Exploring_the_ecosystem_of_ad-based_URL_shortening_services>

### SUMMARY OF INVENTION

### Technical Problem

However, conventionally, a method for reducing a risk of being guided to the above advertisement page having a security risk when a user uses an advertisement type shortened URL service has not been proposed. Therefore, an object of the present invention is to solve the above-described problem and reduce a risk of being guided to a page having a security risk when using an advertisement type shortened URL service.

### Solution to Problem

In order to solve the above-described problems, the present invention includes a display control device including an acquisition unit that acquires an intermediate page including an advertisement, the intermediate page being displayed after a user clicks an advertisement type shortened URL, a screen analysis unit that analyzes HTML source code of the acquired intermediate page and detects a button for transitioning to a web page of an URL of a shortening source or a next intermediate page from the HTML source code, and a display control unit that performs display control to highlight a portion of the button on the intermediate page.

### Advantageous Effects of Invention

According to the present invention, it is possible to reduce a risk that a user is guided to a page having a security risk when using an advertisement type shortened URL service.

### BRIEF DESCRIPTION OF DRAWINGS

FIG. 1 is a diagram illustrating an example of display control of an intermediate page by a display control device.

FIG. 2 is a diagram illustrating an example of an intermediate page.

FIG. 3 is a diagram illustrating an example of a word group representing “button-likeness”.

FIG. 4 is a diagram illustrating an outline of a processing procedure of the display control device.

FIG. 5 is a diagram illustrating a configuration example of the display control device.

FIG. 6 is a diagram illustrating an example of timing of acquiring source code by the display control device.

FIG. 7 is a diagram illustrating an example of scoring by the display control device.

FIG. 8 is a diagram illustrating an example of highlight display of a correct button by the display control device.

FIG. 9 is a diagram illustrating an outline of a processing procedure of the display control device.

FIG. 10 is a flowchart illustrating an example of processing procedure of the display control device.

FIG. 11 is a diagram illustrating a configuration example of a computer that executes a display control program.

### DESCRIPTION OF EMBODIMENTS

Hereinafter, a mode for carrying out the present invention (embodiment) will be described with reference to the drawings. The present invention is not limited to the embodiments.

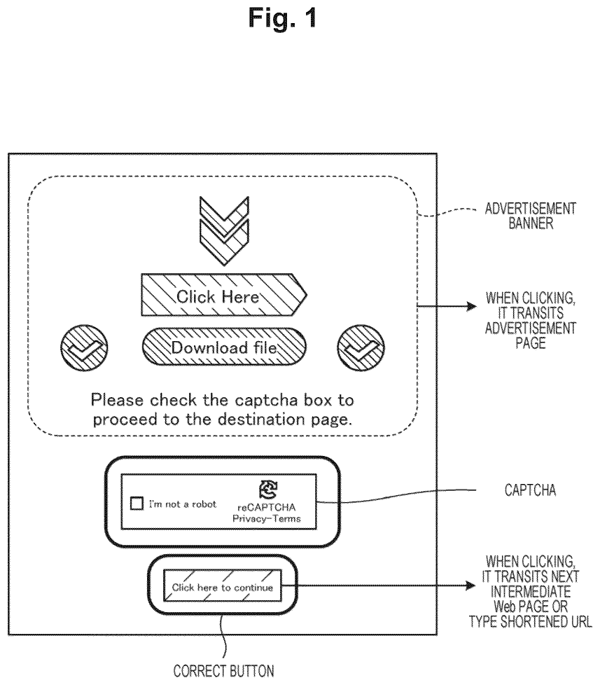

First, an outline of a display control device according to the present embodiment will be described with reference to FIG. 1. The display control device performs display control of the intermediate page displayed after clicking the advertisement type shortened URL. This display control device is realized, for example, when a computer that displays a web page executes an extension program of a web browser.

For example, the display control device acquires an intermediate page displayed after the user clicks the advertisement type shortened URL. Here, when the user clicks an advertisement banner included in the intermediate page, the page transitions to the advertisement page. On the other hand, when the user clicks the correct button of the intermediate page, for example, the transition to the next intermediate page or the URL of the shortening source can be performed.

Therefore, the display control device performs display in which the correct button is highlighted, such as surrounding the location of the correct button on the intermediate page with a red frame.

In this way, the user can easily recognize the portion of the correct button in the intermediate page. As a result, it is possible to reduce the risk that the user misunderstands the correct button, clicks the advertisement banner, and is guided to a page with a security risk.

In addition, some intermediate pages include a CAPTCHA (Turing Test), and the correct button cannot be clicked unless the user resolves the CAPTCHA. In such a case, the display control device also performs display in which the CAPTCHA is emphasized, such as surrounding a portion of the CAPTCHA on the intermediate page with a red frame.

In this way, the user can easily recognize the portion of the CAPTCHA in the intermediate page. As a result, the user can resolve the CAPTCHA and easily click the correct button, so that the risk of being guided to a page with a security risk can be reduced.

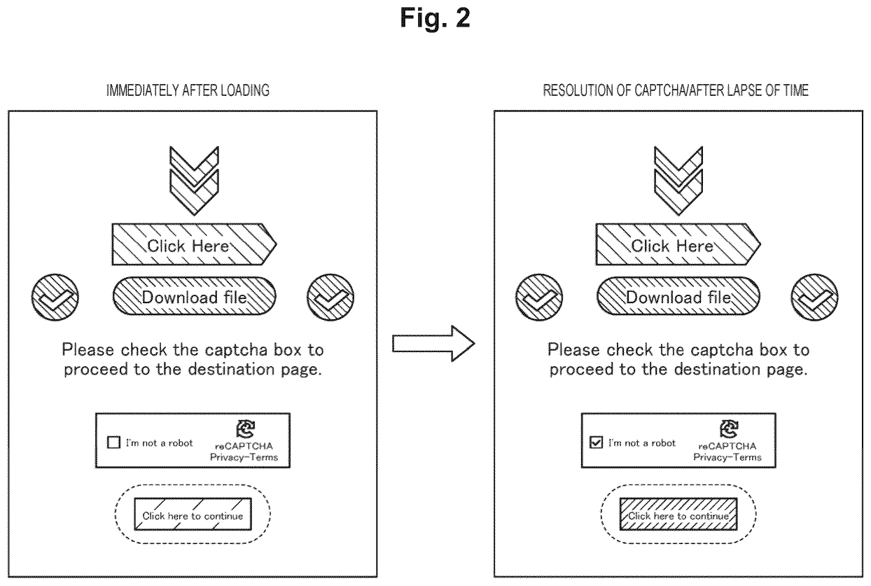

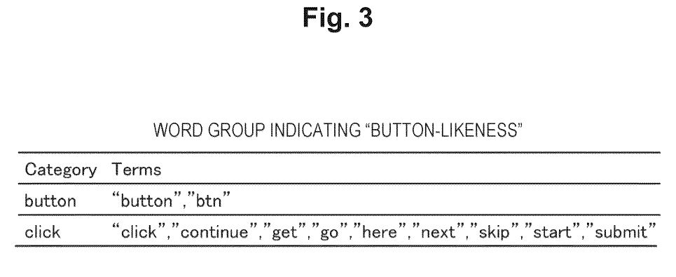

Note that, for example, as illustrated in FIG. 2, the intermediate page is in a state in which the correct button cannot be clicked (or does not exist) immediately after loading, but the correct button can be clicked due to resolution of the CAPTCHA or elapse of time. When the correct button of the intermediate page is brought into a clickable state, the HTML source code of the portion of the correct button changes. For example, the HTML source code of the correct button includes a keyword (see, for example, FIG. 3) indicating the button-likeness such as click here to continue class=btn.

Therefore, the display control device scores each element in the HTML source code of the intermediate page according to how many keywords (see, for example, FIG. 3) indicating the button-likeness are included. In addition, the display control device extracts a difference between the source code of the intermediate page acquired last time and the source code of the intermediate page acquired this time at predetermined time intervals.

Then, the display control device detects, as a correct button, a portion having the highest score among common portions between the extracted difference and the portion having the score of the predetermined value or more. Then, the display control device performs display to highlight the portion of the correct button on the intermediate page.

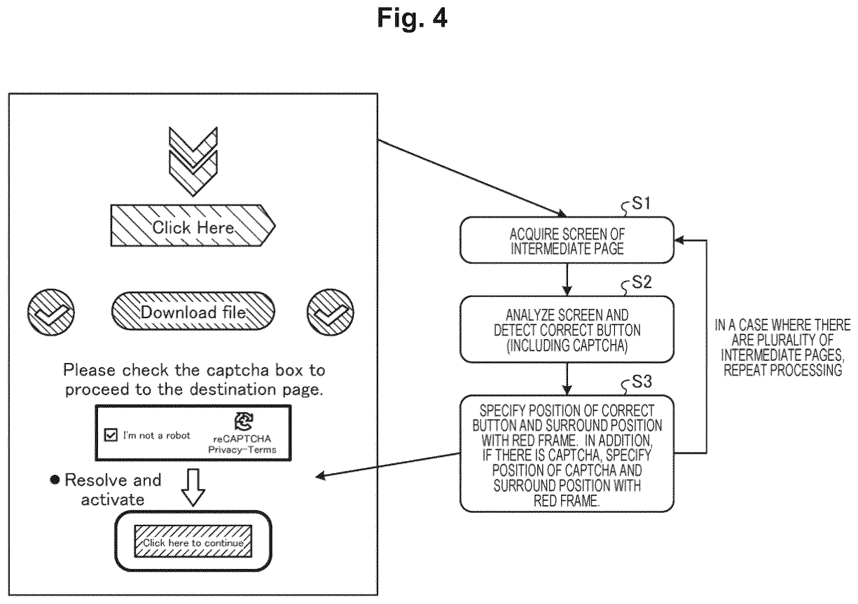

An outline of a processing procedure of the display control device will be described with reference to FIG. 4. For example, when acquiring the screen of the intermediate page (S1), the display control device analyzes the acquired screen and detects the correct button (S2). Further, when the CAPTCHA is included in the intermediate page, the display control device also detects the CAPTCHA. Then, the display control device specifies the position of the correct button in the intermediate page and surrounds it with a red frame. If there is a CAPTCHA, the display control device specifies the position of the CAPTCHA and surrounds the CAPTCHA with a red frame (S3). In a case where there is a plurality of intermediate pages, the display control device repeats the processing of S1 to S3 described above.

In this way, the display control device can reduce the risk of the user being guided to a page with a security risk when using the advertisement type shortened URL service.

### [Configuration Example]

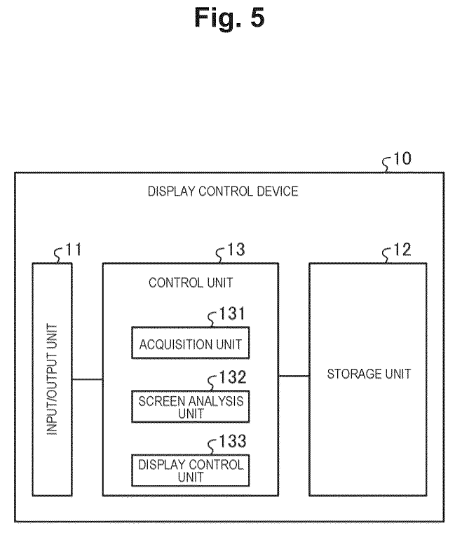

Next, a configuration example of the display control device 10 will be described with reference to FIG. 5. The display control device includes an input/output unit 11, a storage unit 12, and a control unit 13.

The input/output unit 11 is an interface that controls input and output of various types of data. The storage unit 12 stores data to be referred to when the control unit 13 performs various types of processing and data of a processing result of the control unit 13.

For example, the storage unit 12 stores a list (see, for example, FIG. 3) that is referred to by the control unit 13 when scoring the button-likeness of each element of the intermediate page. This list is, for example, a list indicating a word indicating a button and a keyword (word) group prompting the user to click included in the HTML source code of the button.

The control unit 13 controls the entire display control device 10. The control unit 13 includes an acquisition unit 131, a screen analysis unit 132, and a display control unit 133.

The acquisition unit 131 acquires an intermediate page including an advertisement, the intermediate page being displayed after a user clicks an advertisement type shortened URL. Then, the acquisition unit 131 extracts a difference between the intermediate page acquired last time and the intermediate page acquired this time. For example, the acquisition unit 131 acquires the source code of the intermediate page every predetermined time. Then, the acquisition unit 131 extracts a difference by comparing the HTML source code of the intermediate page acquired last time with the HTML source code of the intermediate page acquired this time.

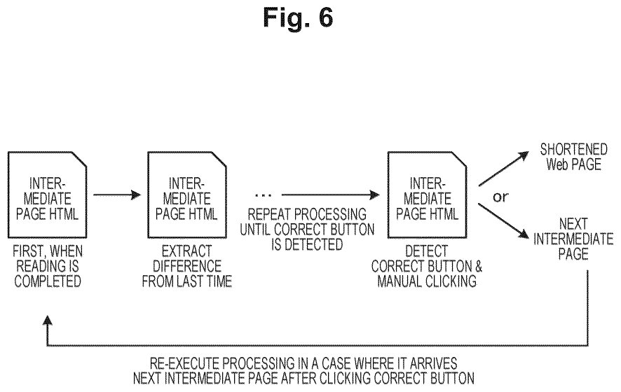

For example, as illustrated in FIG. 6, at the first time, the acquisition unit 131 acquires the HTML source code of the intermediate page when the reading of the intermediate page on which the advertisement is displayed is completed. Thereafter, the acquisition unit 131 repeats the acquisition of the intermediate page every predetermined time (for example, 30 seconds), and detects a difference between the HTML source code of the intermediate page acquired this time and the HTML source code of the intermediate page acquired last time. The acquisition unit 131 repeats the above processing until the correct button is detected by the screen analysis unit 132 (FIG. 6). Note that, in a case where the intermediate page is displayed again after the user clicks the correct button, the acquisition unit 131 executes the above processing again.

In addition, as described above, the acquisition unit 131 acquires the intermediate page and extracts the difference every predetermined time until the correct button is detected, but the present invention is not limited thereto. For example, when detecting that the CAPTCHA of the intermediate page is resolved after the first intermediate page is acquired, the acquisition unit 131 may extract a difference between the intermediate page after the resolution of the CAPTCHA and the first intermediate page.

The description returns to FIG. 5. The screen analysis unit 132 analyzes the HTML source code of the intermediate page acquired by the acquisition unit 131, and detects the correct button from the HTML source code.

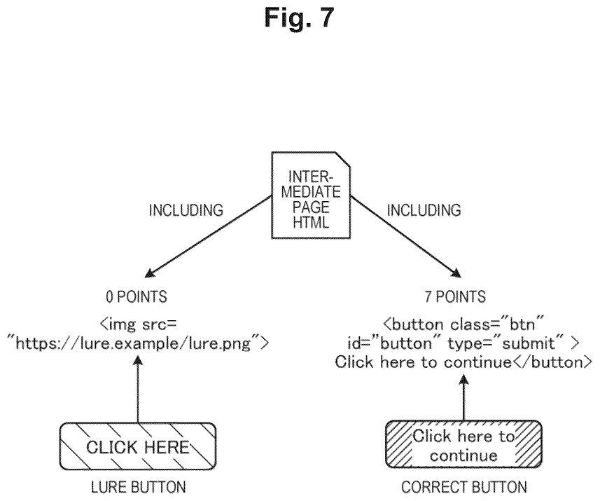

For example, as illustrated in FIG. 7, the screen analysis unit 132 performs scoring according to how many keywords indicating the button-likeness and keywords prompting the user to click (see FIG. 3) are included in the tag name and the attribute value of the HTML source code of the intermediate page acquired by the acquisition unit 131.

For example, the acquisition unit 131 sets the number of keywords indicating the button-likeness included in the tag name or the value of the attribute of the HTML source code of the intermediate page as the value of the score. Then, the screen analysis unit 132 sets an element having a score of a predetermined value or more as a possibility for the correct button.

Then, the screen analysis unit 132 detects a common portion between the difference between the HTML source codes extracted by the acquisition unit 131 and the possibility for the correct button as the correct button.

Further, the screen analysis unit 132 analyzes the HTML source code of the intermediate page acquired by the acquisition unit 131, and detects the CAPTCHA from the HTML source code.

The display control unit 133 performs display control to highlight the portion of the correct button in the intermediate page detected by the screen analysis unit 132. Further, in a case where the CAPTCHA is detected by the screen analysis unit 132, the display control unit 133 performs display control to highlight a portion of the CAPTCHA in the intermediate page.

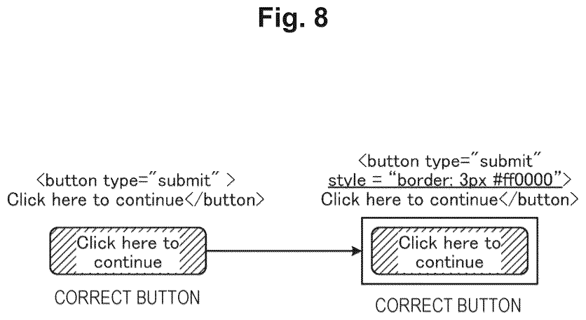

For example, as illustrated in an underlined portion in FIG. 8, the display control unit 133 changes the style of the CSS of the HTML element of the correct button detected by the screen analysis unit 132, and performs display control to surround the correct button with a red frame.

### [Example of Processing Procedure]

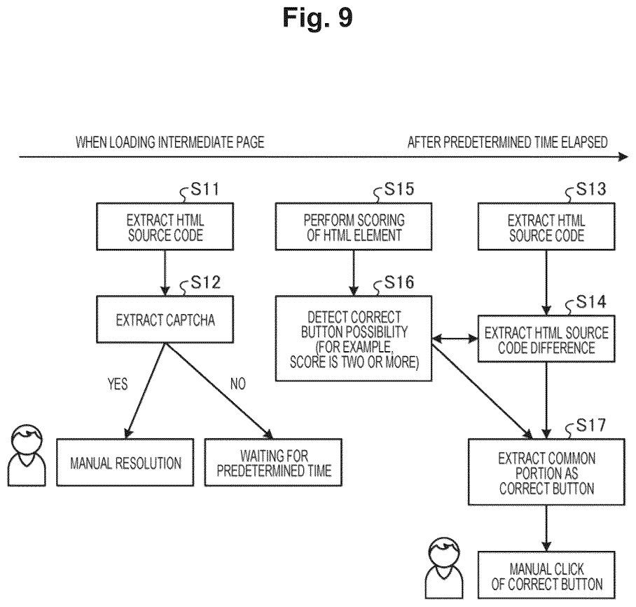

Next, an outline of a processing procedure of the display control device 10 will be described with reference to FIG. 9. First, the display control device 10 extracts the HTML source code of the intermediate page at the time of loading the intermediate page displayed after clicking the advertisement type shortened URL (S11). Thereafter, in a case where the CAPTCHA is extracted from the HTML source code extracted in S11 (“YES” in S12), the display control device 10 highlights the extracted CAPTCHA. Thereafter, the user manually resolves the CAPTCHA of the intermediate page. On the other hand, in a case where the display control device 10 does not extract the CAPTCHA from the HTML source code extracted in S11 (“NO” in S12), the display control device waits for a predetermined time.

After a predetermined time has elapsed since the last extraction of the HTML source code of the intermediate page, the display control device 10 extracts the HTML source code of the intermediate page again (S13). Thereafter, the display control device 10 extracts a difference between the HTML source code of the intermediate page extracted last time and the HTML source code of the intermediate page extracted this time (S14). Furthermore, the display control device 10 performs scoring according to how many keywords (see FIG. 3) indicating the button-likeness are included in the HTML source code extracted this time (S15: Scoring of HTML element). Then, for example, as a result of the scoring, the display control device 10 detects an HTML element having a score of 2 or more as a possibility for the correct button (S16).

Thereafter, the display control device 10 extracts a common portion between the difference of the HTML source code extracted in S14 and the possibility of the correct button detected in S16 as a correct button (S17). Then, the display control device 10 performs highlight display of the correct button extracted in S17. Thereafter, the user manually clicks the correct button on the intermediate page. When the intermediate page is displayed by the manual click, the display control device 10 executes the processing of S11 and subsequent steps again.

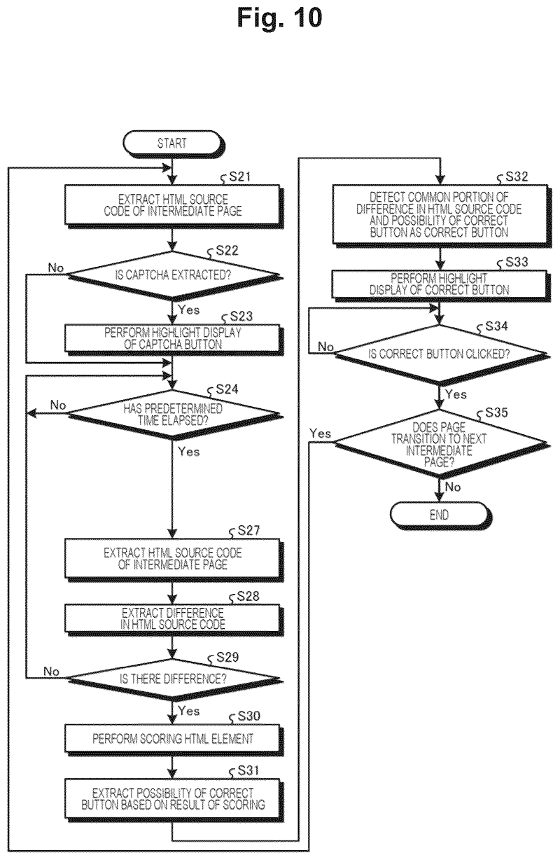

Next, a processing procedure of the display control device 10 will be described in detail with reference to FIG. 10.

For example, the acquisition unit 131 of the display control device 10 extracts the HTML source code of the intermediate page at the time of loading the intermediate page displayed after clicking the advertisement type shortened URL (S21). Then, in a case where the screen analysis unit 132 extracts the CAPTCHA from the HTML source code extracted in S21 (Yes in S22), the display control unit 133 performs highlight display of the CAPTCHA button (S23). Then, after a predetermined time has elapsed (Yes in S24), the processing proceeds to S27. In addition, if the predetermined time has not yet elapsed (No in S24), the processing returns to S24. On the other hand, when the screen analysis unit 132 cannot extract the CAPTCHA from the HTML source code extracted in S21 (No in S22), the processing proceeds to S24.

The acquisition unit 131 extracts the HTML source code of the intermediate page (S27), and extracts a difference between the HTML source code extracted last time and the HTML source code extracted this time (S28). Here, in a case where there is a difference between the HTML source code extracted last time and the HTML source code extracted this time (Yes in S29), the screen analysis unit 132 scores each HTML element depending on how many keywords (see FIG. 3) indicating the button-likeness are included in the HTML element included in the HTML source code extracted in S27 (S30: Scoring of HTML element). On the other hand, in a case where there is no difference between the HTML source code extracted last time and the HTML source code extracted this time (No in S29), the processing returns to S24.

After S30, the screen analysis unit 132 detects a possibility for a correct button based on the result of the scoring in S30 (S31). For example, the screen analysis unit 132 extracts an HTML element having a score of 2 or more as a possibility for a correct button.

After S31, the screen analysis unit 132 detects a common portion between the difference of the HTML source code extracted in S28 and the possibility of the correct button detected in S31 as a correct button (S32). Thereafter, the display control unit 133 highlights the correct button detected in S32 (S33).

After S33, the correct button of the intermediate page is clicked (Yes in S34), and in a case where the page transitions to the next intermediate page (Yes in S35), the processing returns to S21. On the other hand, when the correct button of the intermediate page is not clicked (No in S34), the processing returns to S34. In addition, in a case where the correct button of the intermediate page has been clicked (Yes in S34) but the transition to the next intermediate page has not been made (No in S35), the processing ends.

When display control device 10 performs the above processing, the correct button and the CAPTCHA can be highlighted on the intermediate page displayed when the user uses the advertisement type shortened URL service. As a result, when the user uses the advertisement type shortened URL service, the user can easily click the correct button, so that the risk of being guided to an advertisement page having a security risk can be reduced.

Note that whether the page that has transitioned after the user clicks the correct button of the intermediate page is the next intermediate page or the web page of the URL of the shortening source is determined, for example, by the display control device 10 based on the URL or the domain name of the page that has transitioned, the HTML source code between the page that has transitioned and the intermediate page before transitioning, the similarity of the display screen, and the like.

[System Configuration or the like]

In addition, each component of each unit illustrated in the drawings is functionally conceptual and does not necessarily need to be physically configured as illustrated in the drawings. In other words, a specific form of distribution and integration of each device is not limited to the illustrated form, and all or part thereof can be functionally or physically distributed and integrated in any unit according to various loads, usage conditions, and the like. Furthermore, all or any part of each processing function performed in each device can be implemented by a CPU and a program executed by the CPU, or can be implemented as hardware by wired logic.

In addition, among the processing described in the above embodiment, all or a part of processing described as being automatically performed may be manually performed, or all or a part of processing described as being manually performed may be automatically performed by a known method. In addition, the processing procedures, the control procedures, the specific names, and the information including various data and parameters illustrated in the specification and the drawings can be arbitrarily changed unless otherwise specified.

### [Program]

The display control device 10 described above can be implemented by installing a program (display control program) in a desired computer as package or online software. For example, by causing an information processing device to execute the program, the information processing device can be caused to function as the display control device 10. Here, the information processing device also includes mobile communication terminals such as a smartphone, a mobile phone, and a personal handyphone system (PHS) and terminals such as a personal digital assistant (PDA).

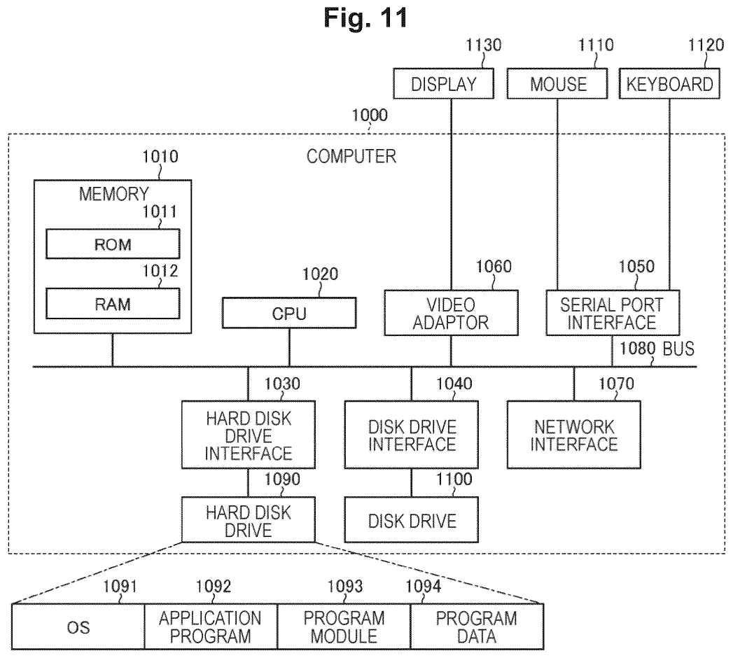

FIG. 11 is a diagram illustrating an example of a computer that executes the display control program. A computer 1000 includes, for example, a memory 1010 and a CPU 1020. Furthermore, the computer 1000 also includes a hard disk drive interface 1030, a disk drive interface 1040, a serial port interface 1050, a video adapter 1060, and a network interface 1070. These units are connected to each other via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected with a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected with, for example, a display 1130.

The hard disk drive 1090 stores, for example, an OS 1091, an application program 1092, a program module 1093, and program data 1094. In other words, a program that defines each type of processing to be executed by the display control device 10 is implemented as the program module 1093 in which codes executable by the computer are described. The program module 1093 is stored in, for example, the hard disk drive 1090. For example, the program module 1093 for executing processing similar to the functional configuration of the display control device 10 is stored in the hard disk drive 1090. Note that the hard disk drive 1090 may be replaced with a solid state drive (SSD).

Data to be used in the processing of the above embodiments is stored in, for example, the memory 1010 or the hard disk drive 1090 as the program data 1094. Then, the CPU 1020 reads the program module 1093 and the program data 1094 stored in the memory 1010 or the hard disk drive 1090 and sends them to the RAM 1012 as necessary to execute them.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (local area network (LAN), wide area network (WAN), or the like). The program module 1093 and the program data 1094 may be read by the CPU 1020 from another computer via the network interface 1070.

### REFERENCE SIGNS LIST

10 Display control device
11 Input/output unit
12 Storage unit
13 Control unit
131 Acquisition unit
132 Screen analysis unit
133 Display control unit

1. A display control device comprising:
acquisition circuitry that acquires an intermediate page including an advertisement, the intermediate page being displayed after a user clicks an advertisement type shortened URL;
screen analysis circuitry that analyzes HTML source code of the acquired intermediate page and detects a button for transitioning to a web page of a URL of a shortening source or a next intermediate page from the HTML source code; and
display control circuitry that performs display control to highlight a portion of the button on the intermediate page.

2. The display control device according to claim 1, wherein:
the screen analysis circuitry analyzes the HTML source code of the acquired intermediate page, performs scoring according to how many keywords indicating a button or keywords prompting a user to click are included in the elements constituting the HTML source code, and detects an element having a score of a predetermined value or more as a result of the scoring as a possibility for the button.

3. The display control device according to claim 2, wherein:
the acquisition circuitry acquires the intermediate page every predetermined time, and detects a difference between an HTML source code of the intermediate page and an HTML source code of the intermediate page acquired one time before, and
the screen analysis circuitry detects, in a case where the difference is detected by the acquisition circuitry, an element having the maximum score among common parts between the difference and an element having the score of a predetermined value or more as the button.

4. The display control device according to claim 1, wherein:
the screen analysis circuitry further analyzes the HTML source code of the acquired intermediate page, and detects a portion of a Turing test for enabling the button to be clicked from the HTML source code, and
the display control circuitry further performs display control to highlight a portion of the Turing test on the intermediate page.

5. A display control method, comprising:
acquiring an intermediate page including an advertisement, the intermediate page being displayed after a user clicks an advertisement type shortened URL;
analyzing HTML source code of the acquired intermediate page and detecting a button for transitioning to a web page of a URL of a shortening source or a next intermediate page from the HTML source code; and
performing display control to highlight a portion of the button on the intermediate page.

6. A non-transitory computer readable medium storing a display control program for causing a computer to execute:
acquiring an intermediate page including an advertisement, the intermediate page being displayed after a user clicks an advertisement type shortened URL;
analyzing HTML source code of the acquired intermediate page and detecting a button for transitioning to a web page of a URL of a shortening source or a next intermediate page from the HTML source code; and
performing display control to highlight a portion of the button on the intermediate page.
